(19) United States
(12) Patent Application Publication
(10) Pub. No.: US 2025/0153544 A1
(43) Pub. Date: May 15, 2025

(54) HEAT-AWAY VENT

(71) Applicants: Todd Novak, Saint Petersburg, FL (US); Jeremiah Novak, Saint Petersburg, FL (US)

(72) Inventors: Todd Novak, Saint Petersburg, FL (US); Jeremiah Novak, Saint Petersburg, FL (US)

(21) Appl. No.: 18/510,139

(22) Filed: Nov. 15, 2023

(51) Int. Cl. B60H 1/24; B60H 1/00

(52) U.S. Cl. CPC B60H 1/248; B60H 1/00778

(57) ABSTRACT

A vent having a housing, a flap that opens and closes, a screen, a housing being configured to attach to a pre-cut or pre-fabricated hole in both the front windshield and a back window of a vehicle, wherein the housing is rectangular and 2-3 inches tall and 3-6 inches wide.

### BACKGROUND

Although it is known for cars to have vents, they have fans which operate using electrical or mechanical power, and therefore only operate while the vehicle is running.

It is known that children occasionally get locked inside a car during the summer, causing them to overheat and die. It is also known that on a 90-degree day, 90 minutes after exiting a car or truck, the interior will reach 138 degrees unless a window is cracked or other preventive action, such as using a sun shield, is taken. After some experimentation, I determined that rolling my 2 foot long window down by ¼ inch resulted in a minimum of a 20 degree temperature drop in the interior; this is about 6 square inches.

### FIELD OF INVENTION

The HEAT-AWAY VENT is in the field of ventilation of a vehicle interior, and is intended to prevent the interior of the passenger compartment from reaching high temperatures while parked by permitting heat to exit through the vent.

### SUMMARY OF THE INVENTION

The HEAT-AWAY VENT permits fresh air to circulate from one end of a vehicle to the other, keeping the interior cooler through the hot months. This will greatly reduce cracks in the dash caused by thermal stress, and deterioration of the leather seats and overhead liner, while permitting people to immediately enter their vehicles instead of waiting to avoid burning themselves on the seats.

In the following description, numerous specific details are set forth to clearly describe the embodiments disclosed herein. However, one skilled in the art will understand that some well known features have not been described in detail so as not to obscure the invention.

### BRIEF DESCRIPTION OF DRAWINGS

The following is a brief description of the drawings:

FIG. 1: cross section side view, interior housing

FIG. 2: inner view of exterior housing

FIG. 3: inner view of back side of flap and part of exterior mold

FIG. 4: overview looking down on exterior mold, seal, and flap from above, as assembled

FIG. 5: side view illustration with vent flap open

FIG. 6: front view of exterior mold including flap

FIG. 7: side view of assembled invention

FIG. 8: seal and screen

FIG. 9: hole in windshield or back window

FIG. 10: inner view of interior mold

FIG. 11: perspective view of vehicle with both front and back windshield vents installed

### DETAILED DESCRIPTION OF DRAWINGS

In the following description, like reference numbers are used to identify like elements. Furthermore, the drawings are intended to illustrate major features of the exemplary embodiments in a diagrammatic manner. The drawings are not intended to depict every feature of every implementation and are not drawn to scale.

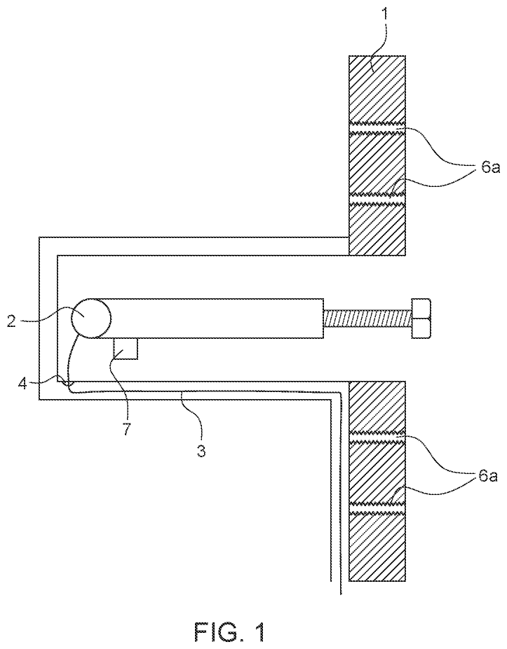

As shown in FIG. 1, the vent includes an interior housing (1), the cross section of which is shown, and which is about ⅛ inch thick. The inner housing includes an extended portion which extends into the interior of the vehicle from a position centered from left to right and positioned near the top of the inner housing, and a flange surrounding the opening of the vent. The extended portion is also ⅛ inch thick, extends approximately 1.5 inches out from the flange, and surrounds an opening approximately 1 inch high, such that a mini actuator motor (2) or equivalent and associated wires (3) fit inside the extended portion. As used in the exemplary embodiment, the mini actuator motor is approximately 1 inch by 2 inches in cross section, but the model and therefore dimensions of the exact motor may vary, and the dimensions of the opening in the extended portion will vary in a corresponding and well understood manner. The extended portion has two holes (4) positioned opposite to each other such that a bolt (5) can pass through both holes and be used to hold the mini actuator motor in place. The flange has 4 holes (6a), one through each corner, appropriately sized for screws to fasten the housings together. The flange extends approximately 2 inches out above and approximately two inches out below the extended portion. The flange is in contact with and attaches to the rubber seal or gasket on the interior portion of the glass.

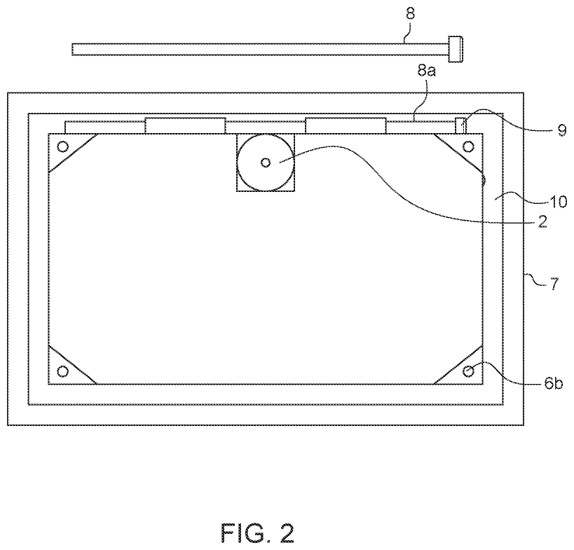

As shown in FIG. 2, the vent includes an exterior housing (7), with an overview being illustrated. The exterior housing is approximately 6 inches wide and 3 inches tall, and the mini actuator motor (2) is centered along the inside of the top of the exterior housing as installed. The exterior housing has an inner lip approximately ½ wide all the way around, making the opening within the housing approximately 5½ inches wide and 2½ inches tall, while the housing is approximately 6 inches wide and 3 inches tall. A horizontal pin (8) runs parallel to the top opening, and acts as the hingepin for the external flap (not shown in FIG. 2) to rotate about. The external mold also includes two hinge portions (8a) for the pin to go through as part of forming the hinge with the flap. A ridge (10) approximately 2 mm or 1/10 in tall surrounds the inner lip about the opening. The exterior housing has 4 threaded holes (6b), one through each interior corner, appropriately sized for screws to fasten the housings together, with the holes in the exterior flange of the inner housing corresponding to the holes in the interior flange of the exterior housing.

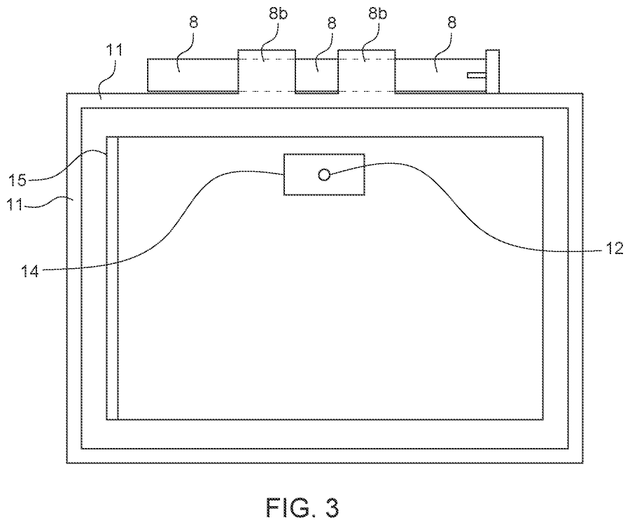

As shown in FIG. 3, the vent includes an external flap (11), used to keep water out of the vehicle. The flap (11) includes three hinge portions (8b) in a corresponding shape with the hinge portions (8a) of the exterior mold, such that the hinge portions (8a, 8b) and the pin (8) form a hinge between the flap and the exterior mold or housing. The flap is approximately ¼ inch thick, and includes flanges on the left, right, and bottom, which are each ⅛ inch thick and extend parallel to the ridge of the exterior housing or mold. The flap is attached to the mini actuator motor in the center upper portion of the flap via connecting rod (12), within the attachment region (14) of the flap 11, to convey motion from the motor to the flap.

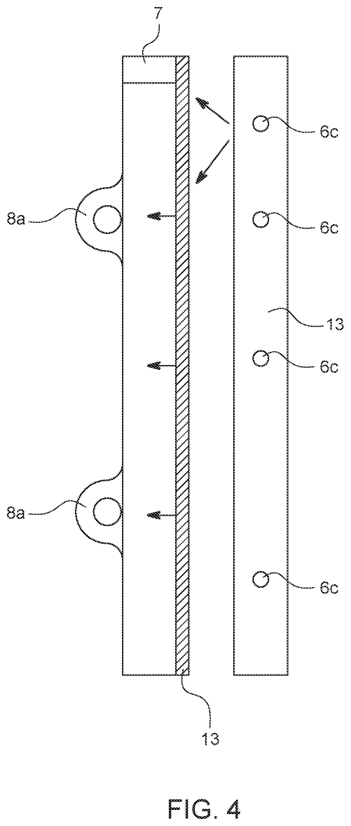

As shown in FIG. 4, the exterior mold or housing (7) is sealed to the glass via a rubber seal (13) or gasket. The interior mold or housing is also sealed to the glass via a rubber seal (13) or gasket. Each rubber seal or gasket (13) is approximately ⅛ inch thick, and the bolts holding the exterior mold and interior mold in place pass through holes (6c) in each of the rubber seals or gaskets (13). As illustrated in both FIGS. 3 and 4, the hinge portions (8a) of the exterior mold are part of the exterior mold, and the hinge portions (8a, 8b) of the exterior mold and flap are each cylindrical in shape. The screws connecting the rubber seal to the top of the flap are countersunk, such that they do not protrude.

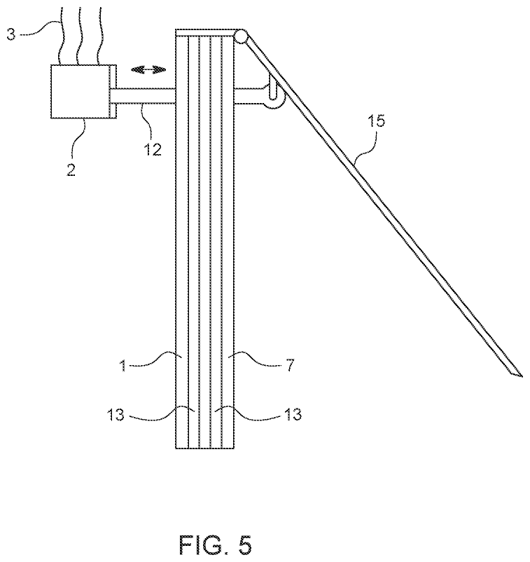

As shown in FIG. 5, the mini actuator motor (2) is within the extended portion of the interior housing (1), the connecting rod (12) passes through the extended portion of the interior housing (not shown), the flange of the interior housing, the first rubber seal or gasket (13), window glass, the second rubber seal or gasket (13), and the exterior housing (7), and connects the mini actuator motor (2) to the flap (11) to open and close the flap as needed. The rubber seal or gaskets (13) protrudes on both sides of the glass such that the interior housing and exterior housing attach to each other through the rubber seal or gasket (13), and the only part in direct contact with the glass of the window or windshield is the rubber seal or gasket (13). The flap is considered to be 50% open when at a 45 degree angle relative to the plane of the outside of the exterior housing, and a 90 degree angle relative to the external housing is considered fully open. FIG. 5 shows the vent as it would be on a fully vertical window.

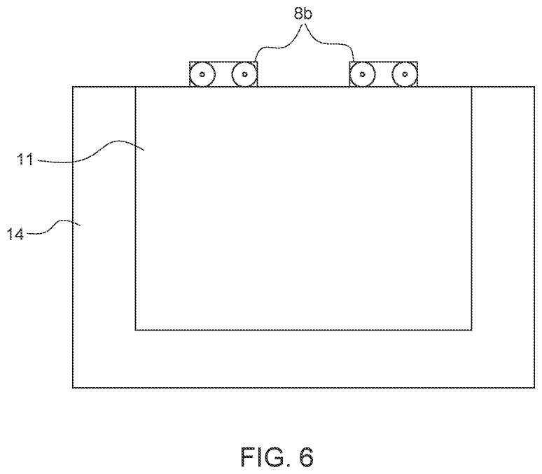

As shown in FIG. 6, the exterior flap (11) is a single piece with three hinge portions (8b) on the top, and a ¼ inch extension (14) on both sides and the bottom of the flap, which is at right angles to the body of the flap.

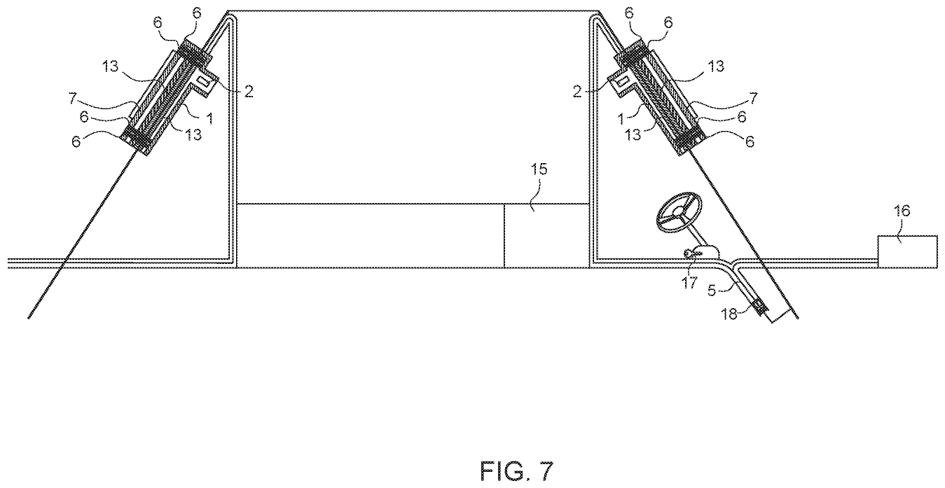

FIG. 7 shows the vent as installed on a windshield, rear windshield, or other window. Most parts in FIG. 7 are the same as those in FIG. 5. FIG. 7 also shows the wiring harness (15) for the mini actuator motor, and wires connecting to the battery (16) of the vehicle, ignition (17) of the vehicle, and an on/off switch (18) for the vent used to open and close the vent manually.

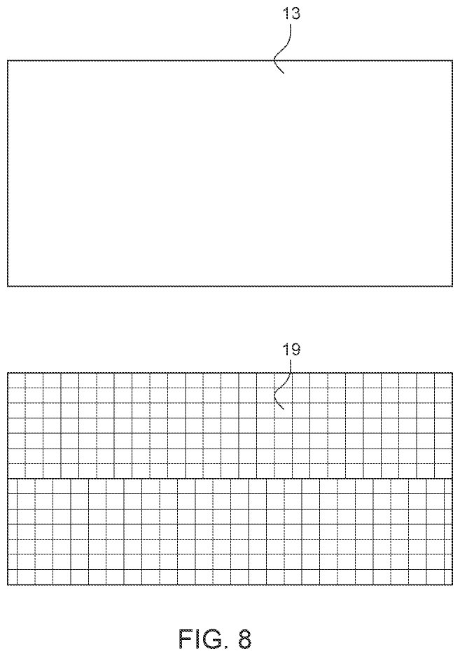

FIG. 8 shows the rubber seal or gasket (13) and screen (19), not assembled.

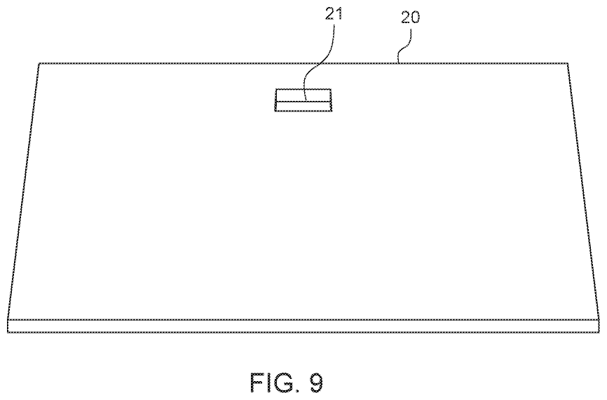

FIG. 9 shows an automobile windshield (20) with a hole (21), referred to in the instructions as a prefabricated hole, for the vent. The hole for the vent may be positioned anywhere along the top of the windshield, and is not confined to the position illustrated so long as it is along the top of the windshield. The hole should be close to the top of the windshield in order to vent the hottest air, but not so close as to impair the structural integrity of the windshield.

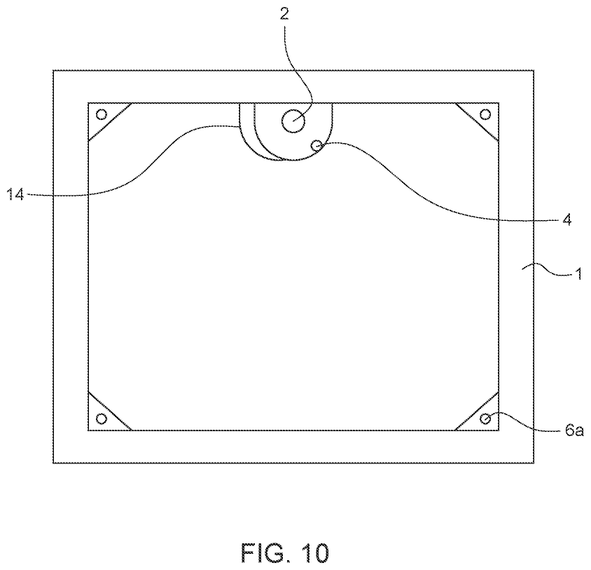

FIG. 10 shows the inner mold, shape, or housing, as viewed from the inside of the vehicle. The mini actuator motor (2) is located in the extended portion of the inner housing, which is centered in the upper portion of the top side of the inner housing. This includes the threaded holes (4) for securing the mini actuator motor with a bolt, and the opening through which the wires from the mini actuator motor must pass to be connected to other components, as well as the holes (6a) to secure the internal and external housings to each other and the flange of the inner housing.

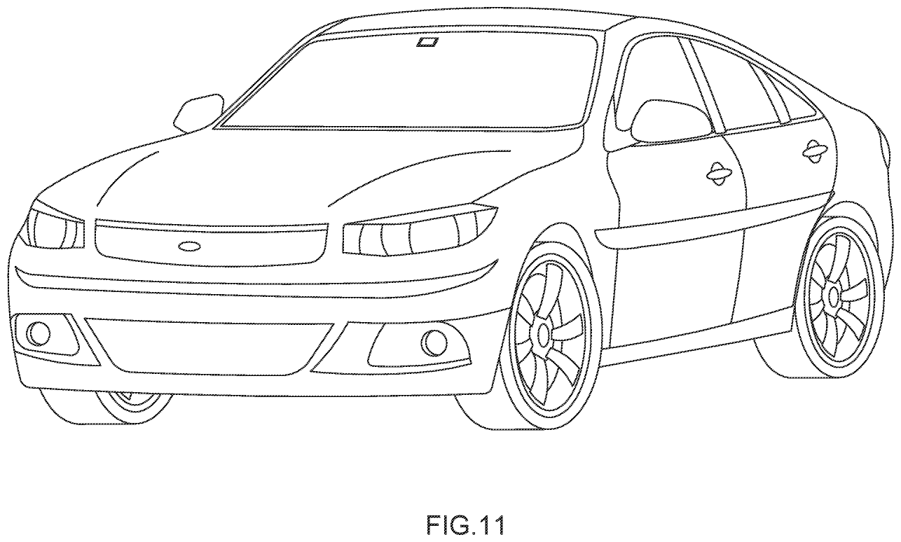

FIG. 11 shows a perspective view of a car with both front and back vents installed.

To install the HEAT-AWAY VENT, perform the following actions:

Preparation step: if there is not one already, cut the hole(s) for the HEAT-AWAY VENT in the front and back windshields. Note that the openings should vary in size according to the size of the interior space of the vehicle; for example, a 4 door SUV should have a hole approximately 3 inches tall by 6 inches wide.

Step 1: Place a rubber gasket or seal which extends to the inside and outside of each of the holes in the windshield and window, such that the vent material is sealed to the window glass via the gasket or seal. The gasket may be attached to the window openings via an adhesive such as superglue.

Step 2: Install the mini actuator motor into the interior of the vent so that it is held in place by 1 or 2 screws (see FIGS. 1, 5, and 7). This includes pulling electrical wires through a small hole in the inside of the body of the vent, so the wires can be connected to the power source for the mini actuator motor. If the vent is configured to provide an audible warning to check the back seat for a child or pet, or to check to ensure the vent has opened as intended, then there will be 4 wires, 2 for power and 2 connected to the speaker; if not configured for providing an audible warning, there will be 2 wires.

Step 3: Place the screen (see FIG. 8) directly over the exterior rubber seal.

Step 4: Use 4 self tapping counter sink screws (see FIG. 4) to attach the rubber seal or gasket to the top of the body of the vent. Then use the pin to connect the exterior flap to the top of the body of the vent using 3 self tapping counter sink screws.

Step 5: Place the body of the vent, which may be plastic, aluminum, or any other suitably all-weather material, directly on the screen. The shape of the vent is illustrated in the figures, and matches the shape of the screen and seal to ensure it is actually sealed to the opening and to prevent leakage of water. As assembled, the flap will have flanges that allow it to protect the vent on three sides from rain.

Step 6: While the mini actuator's motor shaft is in the fully extended or open position, install a single bolt, lock washer, and nut which will connect the moving rod/shaft portion of the mini actuator to the exterior of the vent.

Step 7: Screw in the 4 bolts that will enter the 4 threaded holes in the exterior of the outside vent body through the 4 holes in the screen and into the interior vent body to firmly attach the molds together, forming a secure and watertight seal.

The mini actuator motor will, as installed, automatically set the outer flap to 50% open when the engine is not on, and automatically close the outer flap when the engine is on. This may be accomplished by using the position of the key in the ignition of the vehicle to determine whether or not the engine is on, via a button on a fob (including in response to the signal from a fob to start the vehicle engine), or any other well understood equivalent. The mini actuator motor may also be used to open and close the vent in response to a manual input via a switch.

In an alternative embodiment, not shown, the mini actuator motor is omitted, with a spring or springs being used to permit the vent door to be held open when desired and held closed when desired, in a similar manner to kitchen cabinet doors. This permits the heat away vent to be installed without any electronic components required.

While illustrative embodiments of the invention have been shown and described, variations and alternative embodiments will occur to those skilled in the art. Such variations and alternative embodiments can be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112 (f), unless the element is expressly recited using the exact phrase “means for . . . ” and no method or process step herein is to be construed under the provisions of 35 U.S.C. section 112 (f) unless the step, or steps, are expressly recited using the exact phrase “step(s) for . . . ”.

1. A vent having a housing, a flap that opens and closes, and a screen;
the housing being configured to attach to a pre-cut or pre-fabricated hole in both the front windshield and a back window of a vehicle, the housing being rectangular and 2-3 inches tall and 3-6 inches wide;
the vent being further configured such that when the flap is open it permits fresh air to enter and exit the vehicle, and the vent is configured to open the flap when the vehicle is shut off and not in use and close the flap when the vehicle is on and in use.

2. The vent of claim 1, wherein the vent further comprises an actuator motor installed and configured to open the vent in response to the key of the vehicle being turned to the “OFF” position, and to close the vent in response to the key of the vehicle being turned to the “ON” position.

3. The vent of claim 1, wherein the vent further comprises an actuator motor installed and configured via electrical wires and other components to open the vent in response a signal from a fob or push button indicating the vehicle is turned off, and further configured to close the vent in response to a signal from a fob or push button indicating the vehicle is turned on.

4. The vent of claim 1, further comprising a spring or springs arranged and configured such that the vent door will stay open when manually opened and stay closed when manually closed.

5. The vent of claim 1, wherein the housing is composed of an interior housing, an exterior housing, and a seal which is contact with the glass of the window or windshield and each of the interior housing and the exterior housing.
